(19) United States
(12) Patent Application Publication
(10) Pub. No.: US 2016/0148166 A1
(43) Pub. Date: May 26, 2016

(54) METHOD AND SYSTEM FOR MANAGING SCHEDULE, AND NONTEMPORARY COMPUTER-READABLE RECORDING MEDIUM

(71) Applicant: KONOLABS ,INC., Seoul (KR)

(72) Inventors: Sun Hae KIM, Seoul (KR); Jung Hee RYU, Seoul (KR)

(73) Assignee: KONOLABS, INC, Seoul (KR)

(21) Appl. No.: 14/763,170

(22) PCT Filed: Aug. 14, 2014
(86) PCT No.: PCT/KR2014/007594

§ 371 Date: Jul. 24, 2015

(30) Foreign Application Priority Data
Aug. 14, 2013 (KR) 10-2013-0096889
Oct. 11, 2013 (KR) 10-2013-0120989

(51) Int. Cl. G06Q 10/10

(52) U.S. Cl. CPC G06Q 10/1095

(57) ABSTRACT

According to an aspect of the present invention, a method for managing a schedule is provided. The method comprises the steps of: (a) receiving an event configuration request from a terminal device of a first user and receiving an approval for the event configuration request from a terminal device of a second user involved in an event and (b) determining at least one of time and place of the event with reference to the event configuration request or event information included in the approval, at least some of schedule information of the first user, and at least some of schedule information of the second user.

### FIELD OF THE INVENTION

The present invention relates to a method and system for managing schedule, and a non-temporary computer-readable recording medium therefor.

### BACKGROUND

In order to create a new event in a conventional calendar program (or application), a user should personally find an empty time slot in a time table, and manually enter specific information on the event one by one, such as a to-do item, location, start time, end time, recurrence, and notification time before the event. Therefore, a problem occurs in that the user should take much time and effort to manage schedule. Although a variety of calendar programs are developed recently, those calendar programs simply differ in terms of exterior elements such as designs or titles, and basically have the same problem as above.

Further, a conventional calendar program may only provide schedule management functionality for a single user, and thus, when managing an event in which two or more users are involved, the users cannot avoid the inconvenience of personally contacting each other separately from the calendar program to discuss about the time or location of the event, and entering information on the determined time or location of the event into the calendar program, one by one.

Meanwhile, in order to address the above problem of conventional calendar programs, there have been introduced programs for supporting convenient management of to-do lists. Such a to-do list management program may function to allow a user to conveniently enter and list his/her to-do items and to check the completion of the to-do items, but cannot give consideration to the duration of each to-do item or other events included in the user's schedule. Thus, the program has a limitation in that it is difficult to generally manage the user's schedule using the program.

In this connection, the inventor(s) present a technique whereby a user only needs to enter brief information on an event so that the user's schedule including the event may be automatically managed.

### SUMMARY OF THE INVENTION

One object of the present invention is to solve all the above problems in prior art.

Another object of the invention is to allow a user to enter only brief information on an event so that time or location of the event may be automatically determined in accordance with schedule of multiple users involved in the event, thereby reducing the time and effort required for the user to make plans or appointments.

Yet another object of the invention is to allow a user who will be located in a different time zone due to a travel, business trip or the like to manage schedule in accordance with a local time zone, without personally counting the time difference between the current time zone and the different time zone.

Still another object of the invention is to allow a user to determine and manage his/her leisure time periods (e.g., for taking a rest or promoting self-enrichment) irrespective of schedule of other users.

According to one aspect of the invention to achieve the objects as described above, there is provided a method for managing schedule, comprising the steps of: (a) receiving a request to arrange an event from a terminal device of a first user and receiving an approval for the request to arrange the event from a terminal device of a second user involved in the event; and (b) determining at least one of time and location of the event with reference to event information included in the request to arrange the event or the approval therefor, at least a part of schedule information of the first user, and at least a part of schedule information of the second user.

According to another aspect of the invention, there is provided a system for managing schedule, comprising: a user management unit for receiving a request to arrange an event from a terminal device of a first user and receiving an approval for the request to arrange the event from a terminal device of a second user involved in the event; and an event arrangement management unit for determining at least one of time and location of the event with reference to event information included in the request to arrange the event or the approval therefor, at least a part of schedule information of the first user, and at least a part of schedule information of the second user.

In addition, there are further provided other methods and systems to implement the invention, as well as non-temporary computer-readable recording media having stored thereon computer programs for executing the methods.

According to the invention, a user may enter only brief information on an event so that time or location of the event may be automatically determined in accordance with schedule of multiple users involved in the event, thereby reducing the time and effort required for the user to make plans or appointments.

According to the invention, a user who will be located in a different time zone due to a travel, business trip or the like may manage schedule in accordance with a local time zone, without personally counting the time difference between the current time zone and the different time zone.

According to the invention, a user may determine and manage his/her leisure time periods (e.g., for taking a rest or promoting self-enrichment) irrespective of schedule of other users.

### BRIEF DESCRIPTION OF THE DRAWINGS

FIG. 1 schematically shows the configuration of an entire system for managing schedule according to one embodiment of the invention.

FIG. 2 illustratively shows the internal configuration of a schedule management system according to one embodiment of the invention.

FIG. 3 illustratively shows how an event is arranged according to one embodiment of the invention.

### DETAILED DESCRIPTION OF THE PREFERRED EMBODIMENTS

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the locations or arrangements of individual elements within each of the disclosed embodiments may also be modified without departing from the spirit and scope of the invention. Therefore, the following detailed description is not to be taken in a limiting sense, and the scope of the invention, if properly described, is limited only by the appended claims together with all equivalents thereof. In the drawings, like reference numerals refer to the same or similar functions throughout the several views.

Hereinafter, preferred embodiments of the present invention will be described in detail with reference to the accompanying drawings to enable those skilled in the art to easily implement the invention.

Configuration of the Entire System

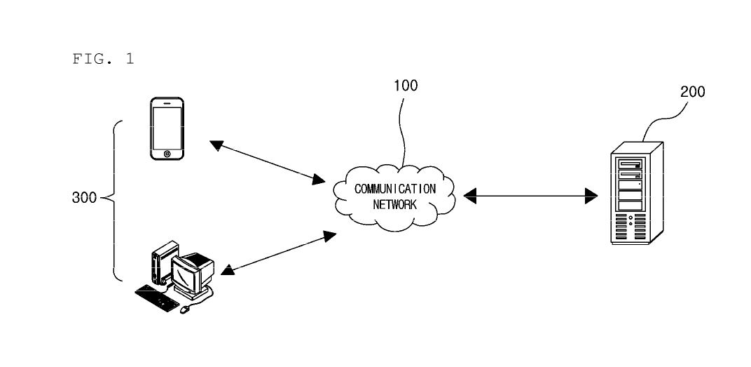

FIG. 1 schematically shows the configuration of an entire system for managing schedule according to one embodiment of the invention.

As shown in FIG. 1, the entire system according to one embodiment of the invention may comprise a communication network 100, a schedule management system 200 and user terminal devices 300.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired or wireless data communication networks, known telephone networks, or known wired or wireless television networks.

Next, the schedule management system 200 according to one embodiment of the invention may function to receive a request to arrange an event from the terminal device 300 of a first user and receive an approval for the request to arrange the event from the terminal device 300 of a second user involved in the event, and to determine at least one of time and location of the event with reference to event information included in the request to arrange the event or the approval therefor, at least a part of schedule information of the first user, and at least a part of schedule information of the second user, so that the time or location of the event may be automatically determined in accordance with schedule of multiple users involved in the event.

The configuration and function of the service providing system 200 according to the invention will be discussed in detail in the following description.

Next, the user terminal device 300 according to one embodiment of the invention is a digital equipment capable of allowing a user to connect to and communicate with the service providing system 200, and may be any type of digital equipment having a microprocessor and memory means for computing capabilities, such as smart phones, tablets, desktop computers, notebook computers, workstations, personal digital assistants (PDAs), web pads, and mobile phones.

Particularly, the user terminal device 300 may include an application (not shown) to support a user to receive services from the schedule management system 200. The application may be downloaded from the schedule management system 200 or a known web server (not shown). It is apparent that the application may be provided by implementing a calendar GUI of a conventional calendar program (e.g., a calendar GUI for schedule management in Microsoft Outlook), as necessary. At least a part of the information to construct the calendar GUI may be received from the schedule management system 200.

Configuration of the Schedule Management System

Hereinafter, the internal configuration of the schedule management system crucial for implementing the present invention and the functions of the respective components thereof will be discussed.

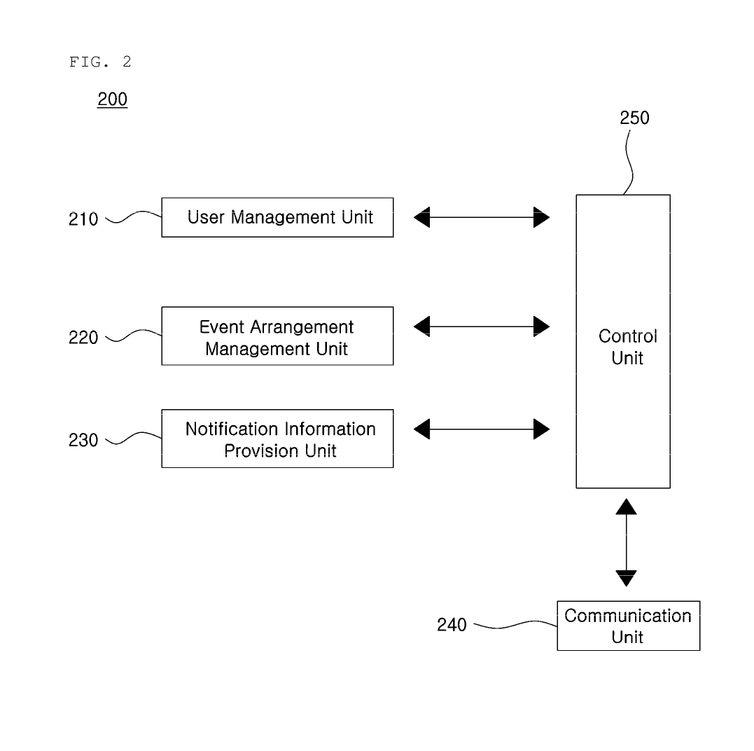

FIG. 2 illustratively shows the internal configuration of the schedule management system according to one embodiment of the invention.

Referring to FIG. 2, the schedule management system 200 according to one embodiment of the invention may comprise a user management unit 210, an event arrangement management unit 220, a notification information provision unit 230, a communication unit 240 and a control unit 250. According to one embodiment of the invention, at least some of the user management unit 210, the event arrangement management unit 220, the notification information provision unit 230, the communication unit 240 and the control unit 250 may be program modules to communicate with an external system (not shown). The program modules may be included in the schedule management system 200 in the form of operating systems, application program modules and other program modules, while they may be physically stored in a variety of commonly known storage devices. Further, the program modules may also be stored in a remote storage device that may communicate with the schedule management system 200. Meanwhile, such program modules may include, but not limited to, routines, subroutines, programs, objects, components, data structures and the like for performing specific tasks or executing specific abstract data types as will be described below in accordance with the invention.

First, according to one embodiment of the invention, the user management unit 210 may receive a request to arrange an event from the terminal device 300 of the first user and receive an approval for the request to arrange the event from the terminal device 300 of the second user involved in the event.

Specifically, according to one embodiment of the invention, the event arrangement request or the approval therefor may include event information entered by the first user who have requested to arrange (e.g., create, modify, delete, or the like) the event, or by the second user who have consented to the arrangement of the event. For example, the event information may include information on title, type, participating users, duration, time limit, preferred locations and the like. According to one embodiment of the invention, the event information may be referred to when time or location of the event is automatically determined.

Further, according to one embodiment of the invention, the user management unit 210 may allow the event arrangement request received from the terminal device 300 of the first user, or the approval received from the terminal device 300 of the second user, to be delivered via e-mail, messaging or social network service (SNS) which the first or second user has joined.

Meanwhile, according to one embodiment of the invention, the user management unit 210 may function to collect personal preference information from the user terminal device 300, based on which time or location of the event is determined as will be described later. For example, the user management unit 220 may collect, from the user terminal device 300, information on basic working hours of the corresponding user (e.g., from 9 am to 6 pm), possible extra working hours of the user (e.g., from 7 am to 10 pm in case of an urgent event), time periods preferred by the user, primary place of the user (e.g., place of work or place of residence), locations preferred by the user (e.g., the closest café or the restaurant of a specific type or price range), time limit by which the event where the user is involved should be arranged (e.g., time and location of the event should be determined no later than one day before the beginning of the event), and the like. According to one embodiment of the invention, the personal preference information collected from the user terminal device 300 may be personally entered by the corresponding user, or may be automatically extracted from information of e-mail, messages and the like relevant to the user.

Next, according to one embodiment of the invention, the event arrangement management unit 220 may function to automatically determine or recommend at least one of time and location of the event, with reference to the event information included in the event arrangement request or the approval therefor, and the accessed schedule information of the first and second users.

Here, according to one embodiment of the invention, the event arrangement management unit 220 may refer to at least a part of the preference information of the first and second users, only within limits permitted by the first and second users, respectively.

Specifically, according to one embodiment of the invention, the event arrangement management unit 220 may refer to the event information and the schedule information of the first and second users in order to determine the time of the event from among the time periods in which no other events exist in the schedule of both of the first and second users (i.e., the common vacant time periods which do not overlap with any of the time of the other events existing in the schedule of the first and second users).

Further, according to one embodiment of the invention, the event arrangement management unit 220 may refer to information on the duration of the event included in the event information in order to determine the time of the event from among the common vacant time periods in which the event may be completed.

Furthermore, according to one embodiment of the invention, the event arrangement management unit 220 may refer to the event information and the schedule information of the first and second users in order to determine, as the location of the event, a location that may minimize the time taken to move from the locations of other events immediately preceding and following the event in the schedule of the first and second users, in view of the determined time of the event.

Moreover, according to one embodiment of the invention, the event arrangement management unit 220 may refer to the event information and the schedule information of the first and second users in order to determine, as the location of the event, a place that the first or second user prefers or frequently visits (e.g., a café with a specific franchise brand), a halfway point between the places of residence of the first and second users, or the like.

In addition, according to one embodiment of the invention, the event arrangement management unit 220 may further refer to context information, which is parsed and extracted from historical message information of e-mail, messages and the like of the first or second user, in order to determine the time or location of the event. For example, the event arrangement management unit 220 according to one embodiment of the invention may refer to the context information included in e-mail composed by a user, which implies that the user wants not to be disturbed by others on Saturday evening, in order to determine the time of the event avoiding Saturday evening time even if there are no other events in the schedule of the user. For another example, the event arrangement management unit 220 according to one embodiment of the invention may refer to the context information included in an SNS message composed by a user, which implies that the user usually sleeps from 12 am to 7:30 am, in order to determine the time of the event from the time period from 7:30 am to 12 am in which the user is mostly in action.

Also, according to one embodiment of the invention, the event arrangement management unit 220 may refer to the event information and the schedule information of the first and second users in order to determine the time or location of the event such that there are leisure time periods in the schedule of the first or second user in which the first or second user may take a rest or promote self-enrichment. Specifically, according to one embodiment of the invention, the event arrangement management unit 220 may determine the time and location of the event from among the time periods that do not overlap with prearranged leisure time periods included in the schedule of the first and second users. Here, the leisure time periods may be arranged according to categories by the first or second user, or may be automatically arranged by the schedule management system 200.

Meanwhile, according to one embodiment of the invention, the event arrangement management unit 220 may automatically determine the leisure time periods for the first user's rest or self-enrichment in the schedule of the first user, avoiding conflict with, in preference to, or irrespective of the schedule of the second user, based on only minimal input to the terminal device 300 of the first user (via an application). To this end, the first user may enter the desired type, duration, frequency in a time period (e.g., frequency in a week) and the like of rest or self-enrichment into the user management unit 210. The type of rest or self-enrichment may be exercising, reading, watching a movie, taking a nap, and the like. Due to the nature of leisure time periods for rest or self-enrichment, the type of each of the leisure time periods may be determined depending on the types of other adjacent events in the schedule of the first user. That is, a leisure time period for a full rest may be determined immediately after a business-type event has been ongoing for a long time or repeated several times, and otherwise a leisure time period for a more active activity may be determined.

Further, according to one embodiment of the invention, the event arrangement management unit 220 may function to adaptively convert the time of events included in the schedule of a user in accordance with a time zone where the user is located. Specifically, according to one embodiment of the invention, the event arrangement management unit 220 may synchronize the time applied to events existing in the schedule of the first user and that applied to events existing in the schedule of the second user, with reference to two different time zones where the first and second users are respectively located. The synchronized event time may be defined as (GMT+n), (GMT+m) and the like, for convenience.

Meanwhile, in order to allow a user who will be located in a different time zone due to a travel, business trip or the like to manage schedule in accordance with a local time zone, without personally counting the time difference between the current time zone and the different time zone, an application may display the time of the user's events on a calendar GUI in accordance with the local time zone, based on location change information on the travel, business trip or the like entered by the user, or may enable the user to enter information on the event time in terms of the time of the local time zone. In the latter case, there is no need to synchronize the time applied to events between two users as described above, and the users may recognize the time of events more intuitively.

Although the embodiments in which the event arrangement management unit 220 automatically determines time or location of an event have been mainly described above, the present invention is not necessarily limited thereto. According to another embodiment of the invention, the event arrangement management unit 220 may refer to the event information and the schedule information of the first and second users in order to recommend time or location of an event to the first or second user, and may confirm the recommended time or location as the time or location of the event only with the consent of the first or second user.

Next, according to one embodiment of the invention, the notification information provision unit 230 may function to provide notification information on an event that is being or has already been arranged to the terminal device 300 of the user involved in the event.

Specifically, according to one embodiment of the invention, when the second user is involved in an event that the first user has requested to arrange, the notification information provision unit 230 may transmit notification information for notifying that the second user is involved in the event to the terminal device 300 of the second user. In this connection, according to one embodiment of the invention, the user management unit 210 may support the second user who has received the notification information to take actions such as approval, disapproval and modification proposal in response the notification information.

Further, according to one embodiment of the invention, when the other user involved in the event that the first user has requested to arrange has taken actions such as approval, disapproval and modification proposal, the notification information provision unit 230 may transmit notification information for notifying that to the terminal device 300 of the first user.

Furthermore, according to one embodiment of the invention, when some of the events included in the schedule of a user are incompletely arranged, or all of them are completely arranged, the notification information provision unit 230 may transmit notification information for notifying that to the terminal device 300 of the user.

In addition, according to one embodiment of the invention, at a specific point of time before the beginning of an arranged event, the notification information provision unit 230 may transmit notification information for reminding the event to the terminal device 300 of the first or second user involved in the event. Here, the specific point of time when the notification information is provided may be personally arranged by each of the first and second users, or may be arranged by the schedule management system 200.

Moreover, according to one embodiment of the invention, the notification information provision unit 230 may transmit notification information for checking whether an event included in the schedule of a user has been carried out, to the terminal device 300 of the user.

Also, according to one embodiment of the invention, the notification information provision unit 230 may transmit notification information on public events (e.g., class hours or holidays), which are basically included in the schedule of a user even though not personally arranged by the user, to the terminal device 300 of the user.

Meanwhile, the communication unit 240 according to one embodiment of the invention may function to enable the schedule management system 200 to communicate with an external device such as the user terminal device 300.

Lastly, the control unit 250 according to one embodiment of the invention may function to control data flow among the user management unit 210, the event arrangement management unit 220, the notification information provision unit 230 and the communication unit 240. That is, the control unit 250 may control inbound data flow or data flow among the respective components of the schedule management system 200, such that the user management unit 210, the event arrangement management unit 220, the notification information provision unit 230 and the communication unit 240 may carry out their particular functions, respectively.

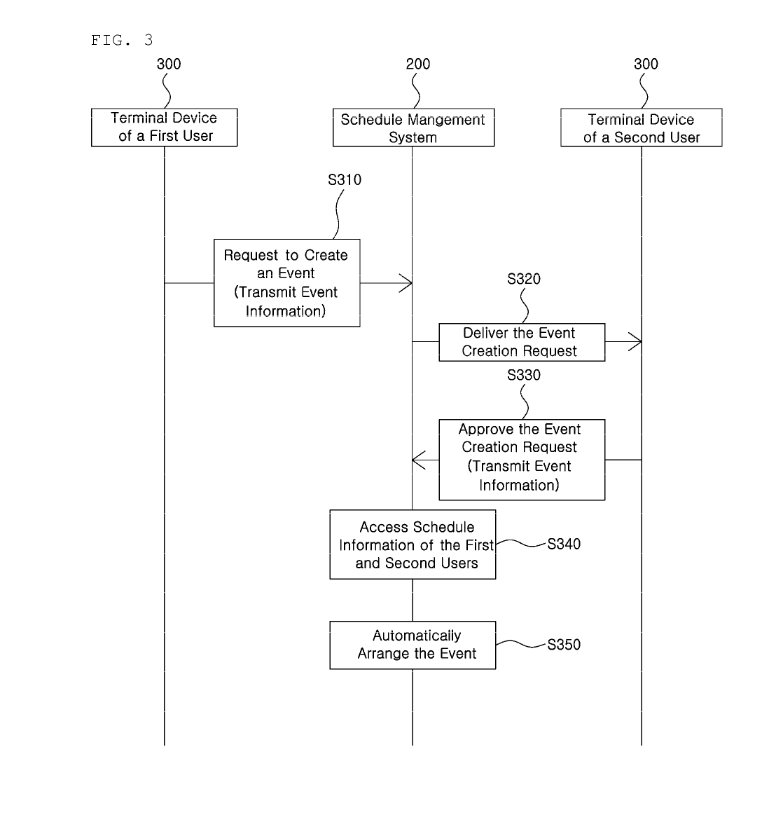

FIG. 3 illustratively shows how an event is arranged according to one embodiment of the invention.

Referring to FIG. 3, the terminal device 300 of a first user may transmit a request to arrange an event (create an event, in the embodiment of FIG. 3), which includes event information entered by the first user, to the schedule management system 200 (S310). The schedule management system 200 may deliver notification information on the request to the terminal device 300 of a second user (S320). The terminal device 300 of the second user may transmit an approval for the event arrangement request, which may include event information entered by the second user, to the schedule management system 200 (S330). Referring further to FIG. 3, the schedule management system 200 may access at least a part of schedule information of the first and second users who have agreed to arrange the event (S340). The schedule management system 200 may refer to the collected event information and the accessed schedule information in order to automatically determine time and location of the event that the first and second users have agreed to arrange, compatibly with the schedule of the first and second users (S350).

Although the embodiments for determining time and location of an event in which two users are involved, with reference to schedule information of the two users, have been mainly described above, the present invention is not necessarily limited to the above embodiments. It is noted that any embodiments for determining time and location of an event in which three or more users are involved, with reference to all schedule information of the three or more users, are also possible.

For example, assuming a case where time and location of an event in which three or more users are involved are determined, the schedule management system 200 according to the invention may refer to schedule information of the three or more users involved in the event in order to extract information on time of at least one other event from the respective schedule information of the three or more users. The time of the event may be determined from among the common vacant time periods that do not overlap with any of the extracted time of the at least one other event.

The embodiments according to the invention as described above may be implemented in the form of program instructions that can be executed by various computer components, and may be stored on a non-temporary computer-readable recording medium. The non-temporary computer-readable recording medium may include program instructions, data files, data structures and the like, separately or in combination. The program instructions stored on the non-temporary computer-readable recording medium may be specially designed and configured for the present invention, or may also be known and available to those skilled in the computer software field. Examples of the non-temporary computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler or the like, but also high-level language codes that can be executed by a computer using an interpreter or the like. The above hardware devices may be configured to operate as one or more software modules to perform the processes of the present invention, and vice versa.

Although the present invention has been described in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

1. A method for managing schedule, comprising the steps of:
(a) receiving a request to arrange an event from a terminal device of a first user and receiving an approval for the request to arrange the event from a terminal device of a second user involved in the event; and
(b) automatically determining at least one of time and location of the event with reference to at least one of event information included in the request to arrange the event or the approval therefor, at least a part of schedule information of the first user, at least a part of schedule information of the second user, personal preference information of the first or second user received from the terminal device of the first or second user, and context information extracted from message information on the first or second user.

2. The method of claim 1, wherein the event information includes at least one of title of the event, type of the event, users to participate in the event, duration of the event, time limit of the event, and location preferred for the event.

3. The method of claim 1, wherein the request or the approval is received via at least one of e-mail, messaging and social network service (SNS) which the first or second user has joined.

4. The method of claim 1, wherein in step (b), at least a part of the schedule information of the first and second users is referred to within limits permitted by the first and second users, respectively.

5. The method of claim 1, wherein in step (b), the time of the event is determined from among common vacant time periods which do not overlap with any of the time of other events existing in the schedule of the first and second users.

6. The method of claim 1, wherein in step (b), a location capable of minimizing the time taken to move from and to the locations of other events immediately preceding and following the event in the schedule of the first and second users, is determined as the location of the event.

7. The method of claim 1, wherein
the personal preference information includes information on at least one of basic working hours, extra working hours, preferred time periods, place of work, place of residence, and preferred locations of the first or second user.

8. (canceled)

9. The method of claim 1, wherein in step (b), the time of the event is determined from among the time periods which do not overlap with leisure time periods each arranged automatically or by the first or second user and included in the schedule of the first or second user.

10. The method of claim 1, wherein in step (b), the time applied to events existing in the schedule of the first user and that applied to events existing in the schedule of the second user are synchronized with reference to time zones where the first and second users are respectively located.

11. The method of claim 1, wherein the at least a part of the schedule information of the first user or the at least a part of the schedule information of the second user is in accordance with a time zone where the corresponding user is located.

12. The method of claim 1, wherein in step (b), the determined time and location is confirmed as the time and location of the event when consents to the determined time and location are received from the terminal devices of the first and second users.

13. The method of claim 1, further comprising the step of:
(c) providing notification information on the event to at least one of the terminal devices of the first and second users at a specific point of time before the beginning of the event.

14. The method of claim 9, wherein
(b) determining the leisure time periods of the first user are automatically arranged based on basic information on the leisure time periods of the first user received from the terminal device of the first user, avoiding conflict with, in preference to, or irrespective of the schedule of the second user, and
wherein the basic information includes at least one of type, duration and frequency of rest or self-enrichment of the first user.

15. A non-temporary computer-readable recording medium having stored thereon a computer program for executing the method of claim 1.

16. A system for managing schedule, comprising:
a user management unit for receiving a request to arrange an event from a terminal device of a first user and receiving an approval for the request to arrange the event from a terminal device of a second user involved in the event; and
an event arrangement management unit for automatically determining at least one of time and location of the event with reference to at least one of event information included in the request to arrange the event or the approval therefor, at least a part of schedule information of the first user, at least a part of schedule information of the second user, personal preference information of the first or second user received from the terminal device of the first or second user, and context information extracted from message information on the first or second user.

17. (canceled)
